(19) United States
(12) Patent Application Publication
(10) Pub. No.: US 2026/0269744 A1
(43) Pub. Date: Sep. 10, 2026

(54) SYSTEMS AND METHOD FOR CONTROLLING AN ELECTRICAL CONVERTER

(71) Applicant: ABB Schweiz AG, Baden (CH)

(72) Inventors: Mario Schweizer, Rütihof (CH); Frederick Kieferndorf, Baden (CH); Ioannis Tsoumas, Zürich (CH)

(21) Appl. No.: 19/469,659

(22) PCT Filed: Apr. 18, 2024
(86) PCT No.: PCT/EP2024/060493

§ 371 Date: Sep. 26, 2025

(30) Foreign Application Priority Data
Apr. 19, 2023 (EP) 23168626.2

(51) Int. Cl. H02M 7/49; H02M 1/00; H02M 1/12; H02M 1/32; H02M 7/5395

(52) U.S. Cl. CPC H02M 7/49; H02M 1/0067; H02M 1/12; H02M 1/325; H02M 7/5395

(57) ABSTRACT

An electrical converter and a method for controlling the converter are provided. The converter comprise: a main stage configured to convert a voltage into an intermediate voltage and having three main outputs, and comprises a stage having three filter cells each coupled to one of the three main outputs and configured to modify a corresponding phase of the intermediate voltage. The converter further comprises three switches configured to bypass the filter cells, each switch being electrically coupled to one of the three main outputs and to a converter output of the electrical converter. The method relates to bypassing a failed filter cell by activating the corresponding switch and determining a modified cell pulse pattern under the assumption that a cell voltage provided by the failed filter cell is zero. The method further relates to modifying intermediate voltage by the two remaining filter cells based on the modified cell pulse pattern.

### CROSS REFERENCE TO RELATED APPLICATIONS

The present application is a national phase entry of International Patent Application No. PCT/EP2024/060493, filed on Apr. 18, 2024, and titled “METHOD AND COMPUTER PROGRAM FOR CONTROLLING AN ELECTRICAL CONVERTER, CONTROLLER FOR CONTROLLING AN ELECTRICAL CONVERTER, ELECTRICAL CONVERTER, AND COMPUTER-READABLE MEDIUM”, which claims priority to European Patent Application No. 23168626.2, filed on Apr. 19, 2023, and titled “METHOD AND COMPUTER PROGRAM FOR CONTROLLING AN ELECTRICAL CONVERTER, CONTROLLER FOR CONTROLLING AN ELECTRICAL CONVERTER, ELECTRICAL CONVERTER, AND COMPUTER-READABLE MEDIUM”, which are hereby incorporated by reference in their entirety.

### TECHNICAL FIELD

The present disclosure relates to the field of high-power converter control. In particular, the present disclosure relates to a method, a computer program, a computer-readable medium and a controller for controlling an electrical converter. The present disclosure also relates to the electrical converter.

### BACKGROUND

In particular in medium voltage applications, a cost-effective electrical converter topology with high power quality is given with the 3L (A) NPC+AF topology. Here, 3L means 3 level, (A) NPC means (active) neutral point clamped and AF means active filter. This topology has been proposed years ago and the corresponding electrical converter may comprise a main stage for providing a three-phase intermediate voltage and a filter stage comprising three AF cells for modifying the three phases of the intermediate voltage for providing an output voltage of the electrical converter. However, optimized hardware design, reliable control and failure-proof operation is still a challenge.

One of the main advantages of the topology are the small voltage steps that can be generated. The small voltage steps reduce the machine-side dv/dt and overvoltages, as well as the current total harmonic distortion and involved harmonic losses in the machine. The benefits come with additional hardware effort and more components hidden in the AF cells. There is a concern that the reliability of the total system may decrease compared to the 3L (A) NPC without active filter due to additional parts count, in particular when one of the AF cells fails.

A corresponding electrical converter, a controller for controlling the electrical converter, and a method for controlling the electrical converter are described in detail in the not yet published patent application EP 22 172 910.6.

To improve the robustness of the system, the filter stage may be equipped with a bypass switch, which may be activated in case that one of the AF cells has a failure. Ideally, the converter system can continue to operate despite the failure. So, all of the AF cells may be bypassed, and the electrical converter may be operated with the main stage of the electrical converter only. However, a power quality of the output voltage will be reduced considerably, and a switching frequency of the main stage would need to be increased by approximately a factor of 5 (from 150 Hz to 450 Hz) to reach an acceptable current total harmonic distortion, for example of less than 5%. However, the increased switching frequency of the main stage may lead to increased switching losses and consequently, a derating in the power capability needs to be applied. Initial calculations of the inventors of the present disclosure have shown that the power derating, depending on the configuration of the drive, can be up to 20%.

Alternatively, a number of AF cells per phase of the intermediate voltage may be higher than required such that a redundant number of AF cells may be installed in every phase. This case is common in MMC or cascaded H-Bridge topologies. If one cell is faulty and needs to be bypassed, there are still enough operational AF cells in the same phase that may be used to filter the corresponding phase of the intermediate voltage. These topologies are typically operated with phase-shifted carrier modulation. However, the modulation concept is not directly compatible with model predictive pulse pattern control (MP3C), a control scheme used for the 3L (A) NPC+AF topology, and the redundant AF cell increase the costs and the complexity of the electrical converter.

### BRIEF DESCRIPTION

It is an objective of the present disclosure to provide a method, a controller, and a computer program for controlling an electrical converter with a main stage and a filter stage having three filter cells, which may contribute to a high quality of an output voltage of the electrical converter, which may be compatible with MP3C, which may enable to keep a switching frequency of the main stage low, and/or which may enable to achieve a low current total harmonic distortion, in particular in case of a failure of one of the filter cells. Further, it is an objective of the present disclosure to provide a computer-readable medium on which the computer program is stored.

These objectives are achieved by the subject-matter of the independent claims. Further exemplary embodiments are evident from the dependent claims and the following description.

An aspect of the present disclosure relates to a method for controlling an electrical converter. The electrical converter comprises a main stage, with the main stage being configured for converting a DC voltage into a three phase intermediate voltage and having three main outputs, one for each phase of the intermediate voltage; a filter cell stage having three filter cells with each filter cell being coupled to a corresponding one of the three main outputs and being configured for modifying the corresponding phase of the intermediate voltage; and three bypass switches for bypassing the filter cells, with each of the three bypass switches being electrically coupled to a corresponding one of the three main outputs and to a cell output of the corresponding filter cell. The method comprises: determining a main stage pulse pattern for the main stage, wherein the main stage pulse pattern is determined depending on a voltage reference signal for the output voltage and wherein the main stage pulse pattern comprises switching instants for the main stage over a next modulation period of the main stage; determining a cell pulse pattern for the filter cell stage, wherein the cell pulse pattern is determined from a cell output voltage reference signal, which is determined from the voltage reference signal and a main stage voltage signal determined from the main stage pulse pattern, and wherein the cell pulse pattern comprises switching instants for the three filter cells over the next modulation period; applying at least a next switching instant determined from the main stage pulse pattern and the cell pulse pattern to the electrical converter, when all of the filter cells are working properly; applying at least a next switching instant determined from the main stage pulse pattern and a modified cell pulse pattern to the electrical converter, when one of the filter cells fails, wherein the failed filter cell is bypassed by activating the corresponding bypass switch, wherein the modified cell pulse pattern is determined under the assumption that a cell voltage provided by the failed filter cell is zero, and wherein the intermediate voltage is modified by the two remaining filter cells depending on the modified cell pulse pattern in order to provide the output voltage of the electrical converter.

So, in the case that one of the filter cells fails, the electrical converter is further operated with the two remaining filter cells. That the electrical converter is operated with the two remaining active filter cells may mean that the electrical converter is operated with the two remaining active filter cells only, namely no further filter cells are used for operating the electrical converter, for example no redundant filter cells.

The above method may contribute to a high quality of the output voltage of the electrical converter, may be compatible with MP3C, may enable to keep a switching frequency of the main stage low, and/or may enable to achieve a low current total harmonic distortion, in particular in case of the failure of one of the filter cells.

In particular, traditional control and modulation schemes (PWM, or MP3C) for the 3L (A) NPC+AF topology assume symmetry in the system, namely all three filter cells are operational. This is the case for PWM, where the best results are achieved with symmetric space vector equivalent modulation. In MP3C, optimal pulse patterns (OPPs) may be used that have been optimized offline for minimal current distortions assuming symmetry in the system. If the symmetry is broken, for example because one AF cell is bypassed, the normal switching sequences may lead to a very low output power quality and should not be used anymore. Under such asymmetric conditions, the way that the reference signals for the remaining filter cells are generated may be changed. The above method for controlling the electrical converter may be used to redistribute a total voltage error from three to two filter cells, as explained below. This redistribution is based on a mathematical transformation, as explained below. This method for controlling the electrical converter allows to fully utilize a compensation voltage in a stationary orthogonal reference frame that may be created with the remaining filter cells in two phases only. The mathematical transformation may ensure that the voltage error may be fully compensated. This may contribute to a high voltage quality. Consequently, the switching frequency of the main converter may be kept low and still a low total harmonic distortion of the current, for example of less than 5%, may be achieved.

Further, the above method for controlling the electrical converter may be made compatible with MP3C. In a nominal speed region, MP3C is using optimized pulse patterns (OPPs). Although it would theoretically be possible to compute OPPs for the specific asymmetric situation with a bypassed filter cell, another solution is presented herewith. After the failure in a filter cell has been detected and the faulty filter cell is bypassed, the control scheme may be switched from OPP based MP3C to carrier-based MP3C with error redistribution (ER-CB-MP3C). This may be done online because the only difference between the two schemes is the way that the pulse patterns and a flux reference trajectory may be calculated. With OPP-MP3C, the pulse patterns and the flux reference trajectory may be calculated offline and loaded into look-up tables during an operation of the electrical converter. With ER-CB-MP3C, the pulse patterns and the flux reference trajectory may be computed online for the next modulation period and stored in the corresponding look-up tables. The main control algorithm designated as MP3C core may take the corresponding pulse patterns and flux reference trajectory from these tables and may control the stator flux to follow the reference trajectory with online manipulations of the corresponding switching patterns.

Compared to other approaches that may be used to control the 3L (A) NPC+AF with a bypassed filter cell, the proposed method for controlling the electrical converter may have the following key advantages: improved reliability, as the converter can continue to operate in case an AF cell has a failure, thereby avoiding any down-time, and a service technician may replace the faulty filter cell in a scheduled maintenance window; improved power quality compared to operation with all filter cells being bypassed, because the operational remaining filter cells are used to increase the power quality, thereby keeping the current total harmonic distortion below a target of, for example, 5%; reduced power derating, because despite the operation with the failed filter cell, the switching frequency of the main converters needs to be increased only slightly, thereby keeping the losses low and the power derating below, for example, 10%; no redundant AF cells are required such that no additional hardware costs except for the cell bypass switches arise; the proposed control and modulation scheme is compatible with MP3C and no additional control scheme needs to be maintained as CB-MP3C is anyway foreseen for low-speed operation; seamless switch-over and uninterrupted operation is possible despite the filter cell failure.

The electrical converter may be a 3L-NPC-converter. The electrical converter may be provided for driving an electrical machine, in particular an electric motor, for example a three-phase motor, such as a three-phase induction motor. A mode in which all three filter cells are working properly may be referred to as “normal operation” of the electrical converter, whereas a mode in which one of the filter cells has failed may be referred to as “failure mode” of the electrical converter. The electrical converter may be a medium or high voltage converter adapted for processing voltages of more than 3 kV.

The main stage may comprise one or more NPC half-bridges, which are connected in parallel to a DC link. The output of the half-bridges may be the intermediate voltage, which may be a multi-phase, in particular three-phase voltage. Dependent on the topology of the main stage, the output voltage may have two, three, five or more voltage levels. In the case of 3L (A) NPC half-bridges, there may be three output voltage levels.

The filter cells may be active filter cells. In this context, the term “active” in the expression “active filter cells” is a part of the name of the corresponding filter cells, defines the type of the corresponding filter cells, and is not representative for the corresponding filter cell being active or not. So, an active filter cell may be active or not, wherein the filter cell may have failed in the latter case. That the two filter cells are “remaining” means in this context that they have not failed and that they are further active. Each filter cell may comprise a cell capacitor providing a cell voltage of the corresponding filter cell, wherein the cell capacitor is connected in parallel with two half-bridges of the corresponding filter cell, with two half-bridges providing a cell input and a cell output of the corresponding filter cell. The filter cell stage may be seen as an active filter of the electrical converter. The bypass switches may be arranged in parallel to the corresponding filter cells.

The method may comprise a pattern determination part for determining the main stage pulse pattern for the main stage, for example with pulse width modulation, and for determining a cell pulse pattern for the filter stage, for example with pulse width modulation, such as described in the above referenced unpublished patent application EP 22 172 910.6. Each pulse pattern may comprise one or more sequences of switching instants over a specific time interval, the modulation period. A switching instant may indicate a time point and/or transition time and switch positions to be switched to at the time point.

The main stage pulse pattern may be determined from the voltage reference signal for the output voltage, which may be provided by an outer control loop. The cell pulse pattern may be determined from the difference of the voltage reference signal and a main stage voltage signal. The main stage voltage signal may be determined from the main stage pulse pattern by determining an output voltage level generated by the main stage pulse pattern over time.

From the main stage pulse pattern and the cell pulse pattern, a flux reference trajectory may be determined, for example as described in the above referenced unpublished patent application EP 22 172 910.6. In particular, this may be done by integrating the sum of the intermediate voltage of the main stage as indicated by the main stage pulse pattern and the filter cell output voltage of the filter cell stage as indicated by the cell pulse pattern. Optionally, the cell pulse pattern may be adjusted before determining the flux reference trajectory, for example as described in the above referenced unpublished patent application EP 22 172 910.6 in context with the adjuster of the pattern determination part.

It has to be noted that the main stage pulse pattern and the cell pulse pattern may be multi-phase quantities, namely there may be switching instants for every phase. Also, the flux reference trajectory may be a vector quantity, for example with a component of each phase, or for example, with two components in an orthogonal reference frame.

Finally, the pulse patterns and the flux reference trajectory may be written into look-up tables and passed to the model predictive control part. The model predictive control part ensures closed loop control by tracking of the provided flux reference trajectory with online-modifications of the provided pulse patterns.

Optionally, one or more differential mode components of a balancing voltage of the filter cells, which is determined from measurements in the filter cells, may be determined and the corresponding differential mode component(s) of the balancing voltage may be subtracted from the voltage reference signal before the main stage pulse pattern is determined. For the balancing voltage, the cell voltages and/or capacitor voltages of the filter cells may be measured to generate a corresponding cell voltage signal. Each phase of the balancing voltage corresponding to one of the filter cells may be based on an average of a difference of a measured cell voltage signal of the filter cell and a reference cell voltage of the corresponding filter cell. The measured cell voltage signals may be filtered with a low pass filter to reduce ripple and/or a cell voltage reference may be subtracted. The balancing voltage of a filter cell may be an average of the thus processed cell voltage signal. A common mode signal, namely the sum of the phase components of the balancing voltage, may then be subtracted from the balancing voltage of a filter cell to determine the differential mode component(s). Similarly, the cell pulse pattern may be determined from cell output voltage reference signal. The cell output voltage reference signal is a difference of the compensated voltage reference signal, which is the difference of the voltage reference signal and the differential mode component(s) of the balancing voltage of the cells, and a differential mode signal of the main stage voltage signal determined from the main stage pulse pattern. In such a way, the differential mode component(s) of the balancing voltage of the filter cells, which has been subtracted from the voltage reference signal for determining the main stage pulse pattern, can be compensated.

According to an embodiment, the cell pulse pattern for the filter cell stage is determined from the cell output voltage reference signal by distributing the cell output voltage reference signal to the three filter cells, when all three filter cells are working properly, and the modified cell pulse pattern for the filter cell stage is determined from the cell output voltage reference signal by distributing the cell output voltage reference signal to the two remaining filter cells, when the filter cell fails.

According to an embodiment, the cell output voltage reference signal is distributed to the two remaining filter cells by determining, under the assumption that all three filter cells work properly, three reference cell output voltages to be provided by the corresponding filter cells depending on the cell output voltage reference signal, wherein the three reference cell output voltages are determined in the form of a three-dimensional vector; determining two auxiliary reference cell output voltages for the two remaining filter cells depending on the reference cell output voltages by transforming the three-dimensional vector into a two-dimensional auxiliary vector, wherein the components of the two-dimensional auxiliary vector correspond to the two auxiliary reference cell output voltages; determining a back-transformation matrix by back-transforming the auxiliary vector under the assumption that a cell output voltage of the failed filter cell is zero; determining two redistributed reference cell output voltages depending on the back-transformation matrix and the two auxiliary reference cell output voltages; and determining the modified cell pulse pattern depending on the redistributed reference cell output voltages. This transformation may be referred to as Clark-Transformation. The two redistributed reference cell output voltages may be determined in form of a two-dimensional redistributed vector. The back-transformation matrix may be a reduced back-transformation matrix.

According to an embodiment, the three-dimensional vector is determined in an abc-frame. Alternatively or additionally, the two-dimension auxiliary vector may be determined in an αβ-frame. Alternatively or additionally, the redistributed reference cell output voltages may be determined in form of a two-dimensional redistributed vector and the redistributed vector is provided in the αβ-frame. Alternatively, the auxiliary vector and/or the redistributed vector may be provided in a dq-frame. The αβ-frame may be stationary and/or orthogonal.

According to an embodiment, the main stage and/or the filter cells are operated in accordance with an OPP-based MP3C modulation scheme, a carrier-based MP3C modulation scheme, or a PWM modulation scheme, when all three filter cells work properly.

The OPP-based MP3C modulation scheme may be used at medium to high speed of the electrical machine, whereas the carrier-based MP3C modulation scheme may be used at a low speed of the electrical machine, both during normal operation of all three filter cells.

Alternatively or additionally, the main stage and/or the remaining filter cells may be operated in accordance with a carrier-based MP3C modulation scheme, when the filter cell has failed.

According to an embodiment, when all of the filter cells work properly, pulse patterns for the main stage and/or for the three filter cells are determined offline in advance and are loaded into one or more look-up tables during the operation of the electrical converter. Alternatively or additionally, when the filter cell has failed, the pulse patterns for the main stage and/or for the remaining filter cells may be determined online for the next modulation period only and may be loaded into the one or more look-up tables during the operation of the electrical converter. The next modulation period may be Tc or Tc/2. The pulse patterns each may consist of switching states and switching times for the three phases.

According to an embodiment, a switching frequency of the main stage is increased, when the filter cell has failed. The switching frequency may be referred to as target switching frequency. The switching frequency may be increased by a factor in the range of 1.5 to 5, for example in the range of 2 to 4, or in some embodiments of about 3. The switching frequency may be increased for example from 50 Hz to 250 Hz, or from 150 Hz to 250 Hz.

According to an embodiment, an update rate for updating the look-up tables is reduced when the filter cell has failed.

According to an embodiment, the update rate is reduced to a modulation period of the main stage or to half the modulation period of the main stage.

Further aspects of the present disclosure relate to a computer program for controlling an electrical converter, which, when being executed by a processor, is adapted to carry out the above method, and to a computer-readable medium, in which such a computer program is stored. Both the pattern determination part and the model predictive control part may be executed as software on one or more processors.

The computer-readable medium may be a floppy disk, a hard disk, an USB storage device, a RAM, a ROM, an EPROM or a FLASH memory. The computer-readable medium may also be a data communication network, for example the Internet, which allows downloading a program code. In general, the computer-readable medium may be a non-transitory or transitory medium.

A further aspect of the present disclosure relates to a controller for controlling the electrical converter. The controller comprises at least one processor configured for carrying out the above method. The controller further comprises a memory which is communicatively coupled to the processor. The memory is configured for storing the main stage pulse pattern for controlling the main stage of the electrical converter, the cell pulse pattern for controlling the filter cell stage of the electrical converter, when all of the filter cells are working properly, and the modified cell pulse pattern for controlling the filter cell stage, when one of the filter cells fails. The controller may comprise a pattern determination controller for performing the pattern determination part of the method. The controller may comprise a model predictive controller for performing the model predictive control part of the method. The controller may comprise one or more further processors, in which the method may run as software. It also may be that the method is at least partially or completely implemented in hardware, such as a DSP or FPGA.

A further aspect of the present disclosure relates to the electrical converter. The electrical converter comprises: the main stage being configured for converting the DC voltage into the three phase intermediate voltage and having the three main outputs, one for each phase of the intermediate voltage; the filter cell stage having the three filter cells with each filter cell being coupled to the corresponding one of the three main outputs and being configured for modifying the corresponding phase of the intermediate voltage; the three bypass switches for bypassing the filter cells, with each of the three bypass switches being electrically coupled to the corresponding one of the three main outputs and to a cell output of the corresponding filter cell.

In general, it has to be understood that features of the method as described in the above and in the following may be features of the computer program, the computer-readable medium, the controller and the electrical converter as described in the above and in the following, and vice versa.

These and other aspects of the present disclosure will be apparent from and elucidated with reference to the embodiments described hereinafter.

### BRIEF DESCRIPTION OF DRAWINGS

The subject-matter of the present disclosure will be explained in more detail in the following text with reference to exemplary embodiments which are illustrated in the attached drawings.

FIG. 1 shows a schematic circuit diagram of an electrical converter according to an embodiment of the present disclosure.

FIG. 2 shows a schematic high-level block diagram of a controller for controlling the electrical converter, according to an embodiment of the present disclosure.

FIG. 3 shows a schematic medium-level block diagram of the controller for controlling the electrical converter, according to an embodiment of the present disclosure.

FIG. 4 shows a schematic medium-level block diagram of another controller for controlling the electrical converter, according to an embodiment of the present disclosure.

The reference symbols used in the drawings, and their meanings, are listed in summary form in the list of reference symbols. In principle, identical parts are provided with the same reference symbols in the figures.

### DETAILED DESCRIPTION

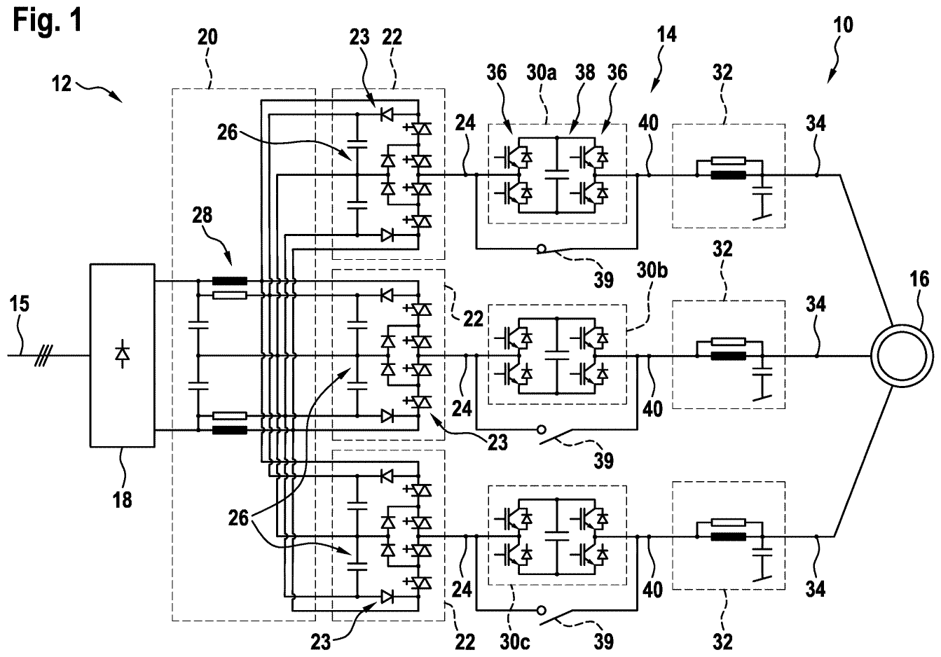

FIG. 1 shows an electrical converter 10 with a main stage 12 and a filter cell stage 14. The electrical converter 10 may be adapted for transforming a first AC voltage provided by a power grid 15 into an output voltage to be supplied to an electrical load 16.

The main stage 12 may comprise a rectifier 18, which may be a passive diode rectifier and which may be adapted for converting the AC voltage from the power grid 15 into a DC voltage, which is supplied to a main DC link 20. The main stage 12 may comprise three output converters 22, each of which being adapted for transforming the DC voltage in the DC link 20 into a corresponding phase of a three-phase intermediate voltage that may be provided at three corresponding main outputs 24 of the main stage 12. The output converters 22 may be connected in parallel to the DC link 20, for example via clamp inductors and/or resistors 28 or directly. Each of the output converters 22 may comprise a clamp circuit 26 and/or DC links 26, for example each with two capacitors. The DC links 20, 26 may be split DC links.

Each of the output converters 22 may comprise, a 3-level neutral point clamped (3LNPC) main half-bridge 23, which may be based on IGCTs, but other topologies and semiconductor types are possible. The main half-bridges 23 also may be ANPC half-bridges. Also, for the overall main stage 12, other topologies may be possible. In general, the main stage 12 may be adapted to provide a two- or multi-level intermediate voltage at the outputs 24, in particular with three phases. The main half-bridges 23 as shown in FIG. 1 may be adapted for generating three different voltage levels for the respective phases of the intermediate voltage.

The inductors 28 may provide an IGCT di/dt clamp circuit. In the case of other types of semiconductor switches, such as IGBTs, the inductors 28 may be omitted. The clamp circuits 26 may be used for controlling a device voltage during switching. The clamp circuits 26, normally used for IGCT switches, may or may not be omitted for other choices of semiconductor switches.

For every phase of the main stage 12, the filter cell stage 14 comprises one filter cell, in particular a first filter cell 30a, a second filter cell 30b, and a third filter cell 30c, and optionally one passive output filter 32, which are connected in series between the respective main output 24 of the main stage 12 and a converter output 34 of the electrical converter 10. The filter cell stage 14 may be seen as an active filter of the electrical converter 10.

Every filter cell 30a, 30b, 30c may comprise two cell half-bridges 36, which may be connected in parallel with a corresponding cell capacitor 38. A first midpoint of one of the cell half-bridges 36 may be connected to the corresponding main output 24 of the main stage 12. A second midpoint of the other one of the cell half-bridges 36 may provide a cell output 40 of the corresponding filter cell 30a, 30b, 30c and is connected via the corresponding optional passive filter 32 with the respective converter output 34 of the electrical converter 10.

Each of the filter cells 30a, 30b, 30c may comprise three different switching states, that may be reached by accordingly switching their semiconductor switches (two per half-bridge), which, for example, may be IGBTs. In a first switching state, the filter cells 30a, 30b, 30c may directly connect the corresponding main output 24 with the corresponding cell output 40. In a second switching state, the filter cells 30a, 30b, 30c may connect the corresponding cell capacitor 38 between the corresponding outputs 24, 40, such that the cell capacitor voltage of the corresponding cell capacitor 38 is added to the intermediate voltage provided at the corresponding main output 24. In a third switching state, the filter cells 30a, 30b, 30c may connect the corresponding cell capacitor 38 between the corresponding outputs 24, 40, such that the cell capacitor voltage of the corresponding cell capacitor 38 is subtracted from the intermediate voltage provided at the corresponding main output 24. In such a way, the intermediate voltage from the main stage 12, which usually is shaped like a step-function due to the finite number of levels of the main stage 12, may be converted into a voltage (namely the output voltage) which better approximates a sinusoidal and/or continuous output voltage reference.

Each of the passive filters 32 may comprise inductors, resistors and/or capacitors for electrical filtering the output voltage for even more damping higher order harmonics.

The filter stage 14 comprises three bypass switches 39 for bypassing the filter cells 30a, 30b, 30c, with each of the three bypass switches 39 being electrically coupled to a corresponding one of the three main outputs 24 and to the corresponding one of the cell outputs 40. So, every bypass switch 39 is configured for bypassing the corresponding filter cell 30a, 30b, 30c, in particular when the corresponding filter cell 30a, 30b, 30c fails. For example, in FIG. 1, the uppermost filter cell 30a has failed and is bypassed by the corresponding bypass switch 39 being closed.

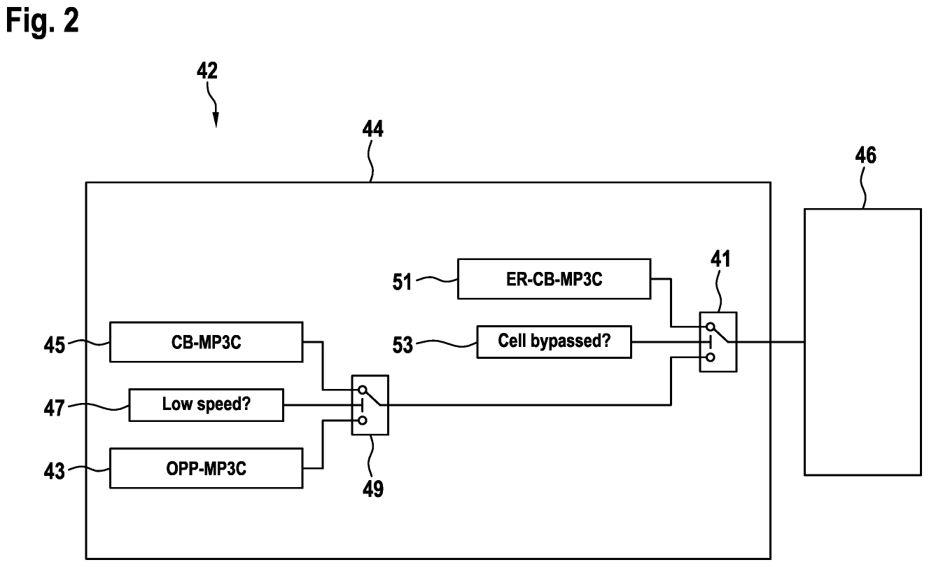

FIG. 2 shows a schematic high-level block diagram of a controller 42 for controlling the electrical converter 10, wherein the controller 42 may comprise a pattern determination controller 44 and a model predictive controller 46. The blocks of the controller 42 may also indicate activities of a method for controlling the electrical converter 10, which may be carried out by the controller 42. The block of the pattern determination controller 44 also may be seen as the pattern determination part of the method for controlling the electrical converter 10. The block of the model predictive controller 46 also may be seen as the model predictive control part of the method for controlling the electrical converter 10.

During normal operation, namely in case of all filter cells 30a, 30b, 30c working properly, the pattern determination part 44 may be executed with a time period T_{c} or T_{c}/2, whereas T_{c} is the carrier period of the main stage 12 for an equivalent carrier-based PWM scheme. For example, when the main stage 12 uses a frequency of 300 Hz, the execution period could be 3.3 ms or 1.65 ms. In general, in MP3C, the type of normal operation mode depends on the electrical load, for example the speed of the corresponding electric machine. In case of operation with medium to high speed, typically an OPP-based MP3C modulation scheme (OPP-MP3C) 43 may be applied, whereas for operation with low speed, a carrier-based MP3C modulation scheme (CB-MP3C) 45 may be used. These modulation schemes are already known and described in detail in WO 2019 137 916 A1, WO 2017 013 125 A1, and in the not yet published patent applications EP 22 172 910.6 and EP 22 183 835.2. Whether the electrical machine runs at medium to high speed or at low speed may be determined by a first decision block 47 which may provide a corresponding input to a first switch 49. The first switch 49 may correspondingly switch from OPP-MP3C 43 to CB-MP3C 45 or vice versa.

After detection of the failure of the faulty filter cell 30a, the generation of the pulse patterns and the flux reference trajectory may be passed from the normal operation under OPP-MP3C 43 or CB-MP3C 45 over to an error redistribution carrier-based MP3C modulation scheme (ER-CB-MP3C) 51. Whether one of the filter cells 30a, 30b, 30c is faulty or not and/or has to be bypassed or not may be determined by a second decision block 53 which may provide a corresponding input to a second switch 41. The second switch 41 may correspondingly switch from the normal operation to the ER-CB-MP3C 51.

After switching to ER-CB-MP3C 51, the main converter target switching frequency may be optionally increased, for example from 50/150 Hz to 250 Hz, such as in order to achieve an acceptable current total harmonic distortion of, for example, less than 5%.

Within ER-CB-MP3C 51, the pulse patterns for the main stage 12 and the remaining filter cells 30b, 30c may be calculated online for the next modulation period T_{c} or T_{c}/2. Finally, the reference trajectory may be created online with the actual combined pulse patterns of the three phases, considering the bypassed filter cell 30a as well as the operational remaining filter cells 30b, 30c.

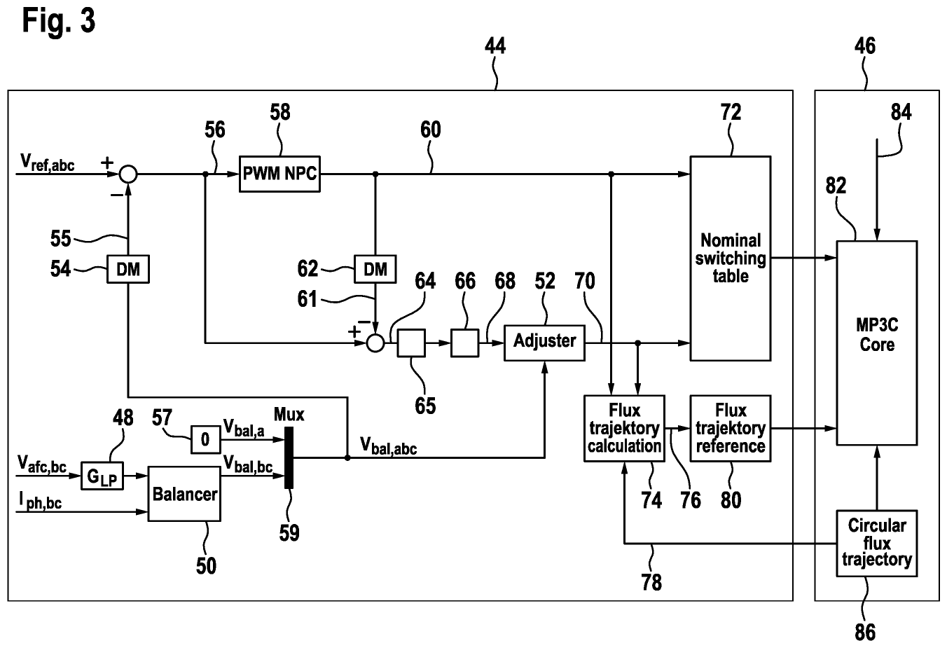

If the pulse pattern and reference trajectory are available for the next modulation period T_{c} or T_{c}/2, they may be stored in lookup tables and may be passed to an MP3C core 82 (see FIG. 3) of the model predictive controller 46. The MP3C core 82 may finally control a stator flux of the electrical machine to follow the flux reference trajectory by manipulating the switching instants of the pulse patterns.

The ER-CB-MP3C 51 may be executed with a reduced update rate, for example with the modulation period of the main stage 12 or half the modulation period. Because the device switching frequency may be increased to 250 Hz, the modulation period and the respective update period may be around T_{c}= 1/500 Hz=2 ms. This may leave enough computational resources for other control tasks, such as an MP3C core algorithm, which may require a high update frequency.

A control algorithm used in the ER-CB-MP3C 51 may follow the schematic block diagram explained with respect to FIG. 3.

FIG. 3 shows a schematic medium-level block diagram of the controller 42 for controlling the electrical converter 10, according to an embodiment of the present disclosure. The control algorithm illustrated by FIG. 3 may be in many parts equivalent to the algorithm of CB-MP3C described in the not yet published patent application EP 22 172 910.6. Therefore, the following description focuses on the new aspects of the present disclosure with respect to the disclosure described in EP 22 172 910.6 and the description of identical components and/or functions may be omitted in order to not obscure the core of the present disclosure.

The control algorithm may be executed with the time period T_{c} or T_{c}/2, whereas T_{c} may be a carrier period of the main stage 12 (3LNPC) for an equivalent carrier-based PWM scheme. If the main stage 12 uses a carrier frequency of 500 Hz, the execution period could be 2 ms or 1 ms. The corresponding computational activities are described in the following.

Based on a flux reference angle provided by an outer loop torque controller, a voltage reference signal V_{ref,abc} for the next modulation period T_{c} (or T_{c}/2) is calculated. The voltage reference signal V_{ref,abc} may be vector-valued. This may be done, for example, by rotating the stator flux reference angle by 90° and scaling the length of the voltage vector with the speed (in case for operation with constant flux reference). For field-weakening, the magnitude of the voltage reference signal V_{ref,abc} may have to be further scaled. To compensate the delay of the pulse width modulation method used below, the angle may be further rotated by an equivalent angle corresponding to T_{c}/2 (or T_{c}/4). The voltage reference signal V_{ref,abc} may further include a common mode voltage signal to balance the neutral potential of the main stage 12 and/or to further improve the voltage quality with space vector equivalent modulation.

The cell capacitor voltages V_{afc,bc} of the two still functional filter cells, e.g the filter cells 30b, 30c in phase b and c, may be measured individually and optionally processed with a low pass filter 48, GLP, wherein it is assumed that the filter cell 30a has failed.

In an active filter cell balancer 50, the differences of the cell capacitor voltages V_{afc,bc} compared to a cell reference voltage may be processed with P- or PI-controllers. Output signals of the filter cell balancer 50 may be interpreted as non-zero first average balancing voltage V_{bal,bc} that need to be injected by the remaining filter cells 30b, 30c in order to accumulate charge in the corresponding cell capacitors 38 of the corresponding remaining filter cells 30b, 30c, and consequently charge or discharge the corresponding cell capacitor 38. If the cell voltage matches the corresponding reference voltage, an average output voltage created by the remaining filter cells 30b, 30c over one modulation period T_{c} (or T_{c}/2) may be zero and the entire volt-seconds over a modulation period may be provided by the main stage 12. In the balancer 50, the signs of the phase currents, in particular the bc-phase currents I_{ph,bc} of the two remaining filter cells 30b, 30c, need to be accounted for, such that the average balancing voltage for the remaining filter cells 30b, 30c may drive the cell voltage in the correct direction, namely the P- or PI-controller outputs may be multiplied with the sign of the corresponding bc-phase currents I_{ph,bc}. The first average balancing voltage V_{bal,bc} of the balancer 50 may be combined with a second average balancing voltage V_{bal,a}, which is a zero signal in the present example, for the bypassed faulty filter cell 30a provided by a second block 57, and may be multiplexed into a third average balancing voltage V_{bal,abc}, for example by a multiplexer 59. The components of the third average balancing voltage V_{bal,abc} may be used as references for a filter cell voltage average adjuster 52.

In block 54, a differential mode (DM) component 55 of the third average balancing voltage V_{bal,abc} may be determined. The differential mode component 55 of the third average balancing voltage V_{bal,abc} may be subtracted from the voltage reference signal V_{ref,abc} to form a compensated voltage reference signal 56. This may be done to compensate an additional voltage injected by the remaining filter cells 30b, 30c caused by the adjustments generated by adjuster 52, as explained in EP 22 172 910.6, in the chapter “Filter cell average voltage adjuster 52”. Consequently, the sum of the output voltage of the main stage 12, namely the intermediate voltage, and the output voltage of the filter cell stage 14 may be unchanged and there may be no impact on the flux trajectory and torque control.

In the main stage modulator 58, the main stage pulse pattern 60 over the next modulation period T_{c} (or T_{c}/2) for the main stage 12 may be calculated from the compensated voltage reference signal 56, for example as explained in EP 22 172 910.6 in the chapter “Main stage pulse width modulator 58”, and in the chapter “pulse width modulation” of EP 3 729 637 A1.

A differential mode signal may 61 be determined in a third block 62 from voltage pulses created by the main stage 12, which are encoded in the main stage pulse pattern 60, for example, in a similar way as the differential mode component 55 is determined from the third average balancing voltage V_{bal,abc}. A cell output voltage reference signal 64, which corresponds to a difference between the compensated reference voltage reference signal 56 and the differential mode signal 61, may be formed. The reference signals for the remaining filter cells 30b, 30c may be determined from the phase components of the cell output voltage reference signal 64.

In particular, an error distributor 65 may be configured for distributing a voltage error which corresponds to the voltage difference encoded in the cell output voltage reference signal 64 to the two remaining filter cells 30b, 30c, wherein the redistributed voltages may be provided as an input to a filter stage modulator 66 for determining an initial cell pulse pattern 68. In particular, the input signal for the filter stage modulator 66 may be determined by the error distributor 65 in a special way that considers the bypassed faulty filter cell 30a and redistributes the voltage error to the two remaining functional filter cells 30b, 30c.

First, the reference voltages for all of the filter cells 30a, 30b, 30c may be calculated under the assumption that all filter cells 30a, 30b, 30c are working properly. In this case, a cell output voltage reference signal V_{ref,af,k} for the filter cell 30a, 30b, 30c in phase k may be determined by

$${V}_{ref \text{,} af , k} ( {t}_{i} ) = {V}_{ref , npc , k} − {V}_{npc \text{,} DM , k} ( {t}_{i} )$$

with k being a, b, or c, with V_{ref,npc,k} being the compensated voltage reference signal, with V_{npc,DM,k} being the differential mode voltage component of the main stage pulse pattern at respective time instant tᵢ of switching position changes, and with tᵢ being the points in time of every switching position change of the main stage pulse pattern 60 in any phase, with i being a natural number.

The cell output voltage reference signal V_{ref,af,k} may be piecewise constant and may change at the time points tᵢ within the modulation period T_{c} (or T_{c}/2). They may be calculated with the actual differential mode voltage component V_{npc,DM,k} for each switching position of the main stage 12 for each switching time in every phase.

$${V}_{npc \text{,} DM , k} ( {t}_{i} ) = {V}_{npc , k} ( {t}_{i} ) - \frac{1}{3} ( {V}_{npc \text{,} a} ( {t}_{i} ) + {V}_{npc \text{,} b} ( {t}_{i} ) + {V}_{npc \text{,} c} ( {t}_{i} ) )$$

with V_{npc,k} being the main stage pulse pattern voltage in phase k, with V_{npc,a} being the main stage pulse pattern voltage in phase a, with V_{npc,b} being the main stage pulse pattern voltage in phase b, with V_{npc,c} being the main stage pulse pattern voltage in phase c, at respective time instants tᵢ of switching position changes. For every switching position change in any phase of the main stage 12, a new entry of the cell output voltage reference signal V_{ref,af,k} with time tᵢ may be created.

Now, the cell output voltage reference signal V_{ref,af,k} in the abc-frame may be redistributed to the remaining functional filter cells 30b, 30c by using a transformation approach. First, the cell output voltage reference signal V_{ref,af,k} in the abc-frame may be transformed to an orthogonal, stationary reference frame (αβ-frame).

$$[ \begin{matrix}{v}_{ref , af , α} ( {t}_{i} ) \\ {v}_{ref , af , β} ( {t}_{i} )\end{matrix} ] = \frac{2}{3} \cdot [ \begin{matrix}1 & − \frac{1}{2} & − \frac{1}{2} \\ 0 & \frac{\sqrt{3}}{2} & − \frac{\sqrt{3}}{2}\end{matrix} ] \cdot [ \begin{matrix}{v}_{ref , af , a} ( {t}_{i} ) \\ {v}_{ref , af , b} ( {t}_{i} ) \\ {v}_{ref , af , c} ( {t}_{i} )\end{matrix} ]$$

In a second activity, the voltage error may be back-transformed to the abc-frame assuming that one cell voltage is zero:

$$\begin{matrix}[ \begin{matrix}{v}_{ref , af , α} \\ {v}_{ref , af , β}\end{matrix} ] = \frac{2}{3} \cdot [ \begin{matrix}1 & − \frac{1}{2} & − \frac{1}{2} \\ 0 & \frac{\sqrt{3}}{2} & − \frac{\sqrt{3}}{2}\end{matrix} ] \cdot [ \begin{matrix}0 \\ {v}_{ref , af , c}^{⋆} \\ {v}_{ref , af , c}^{⋆}\end{matrix} ] \\ = \frac{1}{3} \cdot [ \begin{matrix}− 1 & − 1 \\ \sqrt{3} & − \sqrt{3}\end{matrix} ] \cdot [ \begin{matrix}{v}_{ref , af , b}^{⋆} \\ {v}_{r e f , af , c}^{⋆}\end{matrix} ] = {K}_{b c} \cdot [ \begin{matrix}{v}_{ref , af , b}^{⋆} \\ {v}_{ref , af , c}^{⋆}\end{matrix} ]\end{matrix}$$

Under the assumption of the present example that the faulty filter cell 30a in phase a is bypassed one gets

$$[ \begin{matrix}{v}_{ref , af , b}^{⋆} ( {t}_{i} ) \\ {v}_{r e f , af , c}^{⋆} ( {t}_{i} )\end{matrix} ] = {K}_{bc}^{- 1} \cdot [ \begin{matrix}{v}_{ref , af , α}^{⋆} ( {t}_{i} ) \\ {v}_{r e f , af , β}^{⋆} ( {t}_{i} )\end{matrix} ]$$

$$with$$

$${K}_{bc}^{- 1} = \frac{1}{2} \cdot [ \begin{matrix}- 3 & \sqrt{3} \\ - 3 & - \sqrt{3}\end{matrix} ] \cdot [ \begin{matrix}{v}_{ref , af , α} \\ {v}_{r e f , af , β}\end{matrix} ]$$

being the reduced back-transformation matrix, and with redistributed reference voltages V*_{ref,af,b}, V*_{ref,af,b} being encoded in a new cell output voltage reference signal for the remaining filter cells 30b, 30c in the phases b and, respectively, c. The same principal may easily be transferred to a case where one of the filter cells 30b, 30c is the faulty one.

The phase components of the reference voltage signal may be represented as arrays of voltage and time entries over T_{c} (or T_{c}/2). The same applies to the phase components of the voltage reference signal V_{ref,abc}, for the compensated voltage reference signal 56, and to the main stage pulse pattern 60.

In the filter cell stage modulator 66, the cell output voltage reference signals V_{ref,af,k} for the filter cell stage 14 may be used to determine an initial cell pulse pattern 68 of the filter cell stage 14 over the next modulation period T_{c} (or T_{c}/2), for example as explained in EP 22 172 910.6 in the chapter “Filter cell stage pulse width modulator 66”, wherein only the pulse patterns for the remaining filter cells 30b, 30c may be calculated, because the pulse pattern for the bypassed filter cell 30a may be zero over the complete modulation period. The initial cell pulse pattern 68 may be composed of switching instants for the two remaining phases, wherein each switching instant comprises a switching state and a switching time. The switching times for the initial cell pulse pattern 68 may be provided over next modulation period of the main stage 12. The same applies for a final cell pulse pattern 70. The initial cell pulse pattern 68 may be adjusted to form the final cell pulse pattern 70, for example as described in EP 22 172 910.6.

In block 72, the main stage pulse pattern 60 for the main stage 12 and the cell pulse pattern 70 for the filter cell stage 14 may be stored in a look-up table. There, the pulse patterns 60, 70 may be available for the next modulation period T_{c} (or T_{c}/2) for the model predictive controller 46.

In block 74, the flux reference trajectory 76 corresponding to the main stage pulse pattern 60 and the cell pulse pattern 70 may be calculated, for example as described in EP 22 172 910.6 in chapter “Flux trajectory calculation block 74”.

With pulse width modulation, at the beginning of the modulation period T_{c} (or T_{c}/2), the flux reference trajectory 76 always crosses a circular reference trajectory 78. Therefore, the circular reference trajectory 78 corresponding to the stator flux reference angle at the beginning of the modulation period T_{c} (or T_{c}/2) may be used as a starting point to calculate the flux reference trajectory 76. The rest of the flux reference trajectory 76 over the modulation period T_{c} (or T_{c}/2) may be obtained with piecewise integration of the combined pulse patterns 60, 70 of the main stage 12 and the filter cell stage 14.

In block 80, the flux reference trajectory 76 may be stored in a look-up table. There, the flux reference trajectory 76 may be available for the next modulation period T_{c} (or T_{c}/2) for the model predictive controller 46.

It is also possible that the pattern determination controller 44 calculates the pulse patterns 60, 70 and the flux reference trajectory 76 for the over-next modulation period T_{c} (or T_{c}/2). This may simplify an implementation on a microcontroller because the method may be run in a lower-priority interrupt and may compute the patterns 60, 70 for the over-next modulation period while the model predictive controller 46 works on the active modulation period that has been computed previously.

The model predictive controller 46 may comprise an MP3C (model predictive pulse pattern control) core 82, which may execute the pulse patterns 60, 70 and controls the stator flux to follow the flux reference trajectory 76. For this, the MP3C core 82 may read the pulse patterns 60, 70 and the flux reference trajectory 76 from the look-up tables and may receive an estimated flux 84, which may be calculated from measurements in the electrical converter 10.

The model predictive control part as well as the model predictive control may be performed like in EP 2 469 692 A1, which is incorporated by reference. Also, in the chapter “pattern controller” of EP 3 729 637 A1, which is incorporated by reference, model predictive control of pulse patterns created based on pulse width modulation is described.

In general, the tasks and/or method activities of the model predictive control part may be performed several times during modulation period T_{c} (or T_{c}/2).

The main stage pulse pattern 60 and the cell pulse pattern 70 may be modified by moving at least one transition time and/or time point of a switching instant, such that a flux error determined from a difference between the estimated flux 84 of the electrical converter 10 and the reference flux trajectory 76 is minimized, for example as described in EP 22 172 910.6. To this end, an objective function is used, into which the transition times and/or time points of the switching instants are input.

At least a next switching instant from the modified main stage pulse pattern 60 and the modified cell pulse pattern 70 may then be applied to the electrical converter 10, wherein the faulty filter cell 30a is bypassed by the corresponding bypass switch 39. This may mean that the switches of the main stage 12 and the filter cell stage 14 are switched at the transition time of the next switching instant to the switching position as indicated by the next switching instant.

The circular flux reference trajectory 78 may be calculated in block 86. In case there is a torque step or any other disturbance that leads to a stator flux reference angle which is outside of the angle range corresponding to the precomputed modulation period T_{c} (or T_{c}/2), the flux reference trajectory 76 is skipped and the circular flux reference trajectory 78 at the stator flux reference angle is used instead.

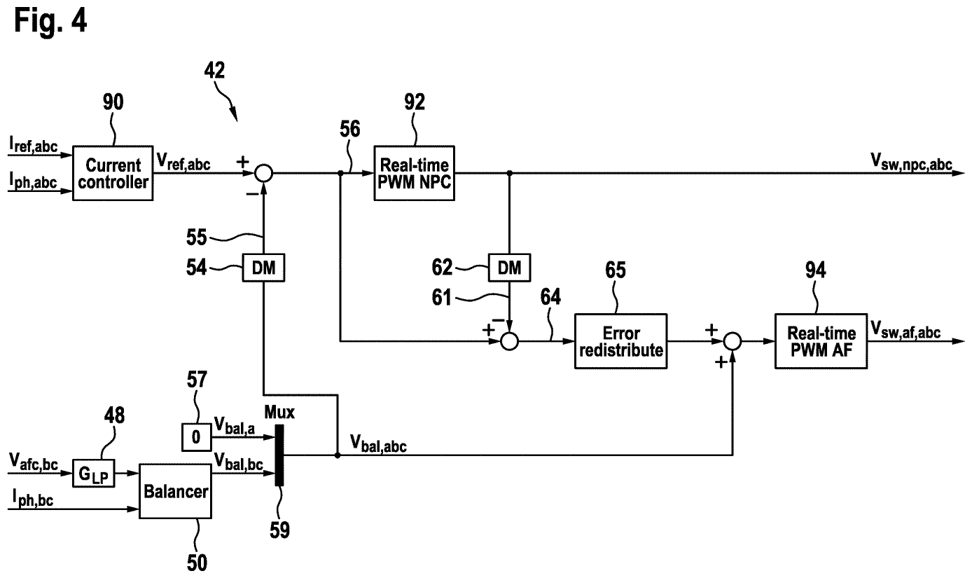

FIG. 4 shows a schematic medium-level block diagram of another controller 42 for controlling the electrical converter 10, according to an embodiment of the present disclosure. From FIG. 4 it may be seen that the method for controlling the electrical converter 10 explained with respect to FIGS. 2 and 3 may also be implemented with a standard current control method, for example in synchronous dq-reference frame and real-time PWM. An important feature is again the error distributor 65 which may be activated in case one of the filter cells 30a, 30b, 30c is bypassed and the filter cell balancer 50.

In this case, the switching signals for all the switches of the 3L (A) NPC and the filter cells 30a, 30b, 30c may not be calculated ahead of time, but instantaneously with real-time PWM modulator blocks 92, 94, that may apply a triangular carrier modulation. Furthermore, instead of the stator flux, typically the currents may be directly controlled, for example in a synchronous orthogonal dq-reference frame, or in any other reference frame, such as described in WO 2018 029 303 A1 and EP 3 709 497 A1.

With respect to FIG. 4, phase output currents I_{ph,abc} may be measured and controlled to follow current references I_{ref,abc}. For this purpose, these two signals may be processed with a current controller 90, which may carry out any kind of a known standard current control method, for example proportional (P), proportional-integral (PI), proportional-integral-derivative (PID), or proportional-resonant (PR) type control in an arbitrary reference frame, for example the three-phase stationary abc-reference frame, the stationary orthogonal αβ-reference frame, or the synchronous dq-reference frame. The current controller 90 may ultimately compute the voltage reference signal V_{ref,abc} in real-time.

In the following, it is again assumed that the filter cell 30a has failed and that the filter cells 30b, 30c are remaining and as such working properly. However, the concept explained in the following may be easily transferred to a case in which one of the other filter cells 30b, 30c fails.

The first average balancing voltage V_{bal,bc} for the remaining two filter cells 30b, 30c may be computed in real-time from the difference of the cell voltage reference and the actual measured cell capacitor voltages V_{afc,bc} of the remaining two filter cells 30b, 30c, which may be filtered with the low-pass filter 48, wherein the difference may be multiplied with the current sign of the bc-phase current I_{ph,bc} of the remaining two filter cells 30b, 30c to achieve cell voltage balancing in the correct direction and it may be processed with a proportional (P) or proportional-integral (PI) controller in order to control the actual measured cell voltages towards the cell voltage reference.

The first average balancing voltage V_{bal,bc} in real-time for the two remaining filter cells 30b, 30c may be multiplexed with the zero signal of the second average balancing voltage V_{bal,a} for the bypassed filter cell 30a to form the three-phase third average balancing voltage V_{bal,abc}.

The differential mode (DM) components 55 of the three-phase third average balancing voltage V_{bal,abc} in real-time may be subtracted from the voltage reference signals V_{ref,abc} to form the compensated voltage reference signal 56 in real-time.

The compensated reference signal 56 in real-time may be processed with a first real-time PWM modulation block 92 of the above mentioned real-time PWM modulator blocks 92, 94, wherein the first real-time PWM modulation block 92 may apply a triangular carrier modulation, to generate the three-phase switching signals for the main stage 12 and corresponding main stage output voltages V_{sw,npc,abc}.

The cell output voltage reference signal 64 in real-time may be determined form the difference of the compensated voltage reference signal 56 and the differential mode (DM) signal 61 determined from the main stage output voltages V_{sw,npc,abc}.

Subsequently, the cell output voltage reference signals 64 in real-time may be redistributed to the two remaining filter cells 30b, 30c by the error distributor 65 that may work in the same way as described above with respect to FIG. 3, but with the real-time signals.

The three phase third balancing voltage signals V_{bal,abc} may be added to the redistributed reference voltages v*_{ref,af,b}, V*_{ref,af,b} to form reference signals for a second real-time PWM modulator block 94 of the above mentioned real-time PWM modulator blocks 92, 94, wherein the second real-time PWM modulator block 94 may apply any known triangular carrier modulation. As such, the second real-time PWM modulator block 94 may create switching signals for the filter stage 14, for example, in the form of filter stage output voltages V_{sw,af,abc}.

While the present disclosure has been illustrated and described in detail in the drawings and foregoing description, such illustration and description are to be considered illustrative or exemplary and not restrictive; the present disclosure is not limited to the disclosed embodiments. Other variations to the disclosed embodiments can be understood and effected by those skilled in the art and practicing the present disclosure, from a study of the drawings, the disclosure, and the appended claims. In the claims, the word “comprising” does not exclude other elements or activities, and the indefinite article “a” or “an” does not exclude a plurality. A single processor or controller or other unit may fulfil the functions of several items recited in the claims. The mere fact that certain measures are recited in mutually different dependent claims does not indicate that a combination of these measures cannot be used to advantage. Any reference signs in the claims should not be construed as limiting the scope.

The disclosed systems and methods are not limited to the specific embodiments described herein. Rather, components of the systems or activities of the methods may be utilized independently and separately from other described components or activities.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

1. A method for controlling an electrical converter, the electrical converter comprising:
a main stage, wherein the main stage is configured to convert a direct current (DC) voltage into a three phase intermediate voltage and having three main outputs, one for each phase of the intermediate voltage;
a filter cell stage having three filter cells, wherein:
each filter cell is coupled to a corresponding one of the three main outputs, and
the filter cell stage is configured to modify the corresponding phase of the intermediate voltage; and
three bypass switches configured to bypass the filter cells, wherein each of the three bypass switches is electrically coupled to a corresponding one of the three main outputs and to a cell output of the corresponding filter cell; and
the method comprising:
determining a main stage pulse pattern for the main stage, wherein the main stage pulse pattern is determined based on a voltage reference signal for the output voltage and wherein the main stage pulse pattern comprises switching instants for the main stage over a next modulation period of the main stage;
determining a cell pulse pattern for the filter cell stage, wherein the cell pulse pattern is determined from a cell output voltage reference signal, which is determined from the voltage reference signal and a main stage voltage signal determined from the main stage pulse pattern, and wherein the cell pulse pattern comprises switching instants for the three filter cells over the next modulation period;
applying at least a next switching instant determined from the main stage pulse pattern and the cell pulse pattern to the electrical converter, when all of the filter cells are working properly; and
applying at least a next switching instant determined from the main stage pulse pattern and a modified cell pulse pattern to the electrical converter, when one of the filter cells fails, wherein:
the failed filter cell is bypassed by activating a corresponding bypass switch of the three bypass switches,
the modified cell pulse pattern is determined by assuming that a cell voltage provided by the failed filter cell is zero, and
the intermediate voltage is modified by the two remaining filter cells based on the modified cell pulse pattern in order to provide the output voltage of the electrical converter.

2. The method of claim 1, wherein:
the cell pulse pattern for the filter cell stage is determined from the cell output voltage reference signal by distributing the cell output voltage reference signal to the three filter cells, when all three filter cells are working properly, and
the modified cell pulse pattern for the filter cell stage is determined from the cell output voltage reference signal by distributing the cell output voltage reference signal to the two remaining filter cells, when the filter cell fails.

3. The method in accordance with claim 2, wherein the cell output voltage reference signal is distributed to the two remaining filter cells by:
determining, by assuming that all three filter cells work properly, three reference cell output voltages to be provided by the corresponding filter cells based on the cell output voltage reference signal, wherein the three reference cell output voltages are determined in the form of a three-dimensional vector;
determining two auxiliary reference cell output voltages for the two remaining filter cells based on the reference cell output voltages by transforming the three-dimensional vector into a two-dimensional auxiliary vector, wherein the components of the two-dimensional auxiliary vector correspond to the two auxiliary reference cell output voltages;
determining a back-transformation matrix by back-transforming the auxiliary vector by assuming that a cell output voltage of the failed filter cell is zero;
determining two redistributed reference cell output voltages based on the back-transformation matrix and the two auxiliary reference cell output voltages; and
determining the modified cell pulse pattern based on the redistributed reference cell output voltages.

4. The method in accordance with claim 3, wherein:
the three-dimensional vector is determined in an abc-frame.

5. The method in accordance with claim 1, wherein;
the main stage and/or the filter cells are operated in accordance with an optimized pulse patterns-based model predictive pulse pattern control (M3PC) modulation scheme, a carrier-based MP3C modulation scheme, or a pulse width modulation (PWM) modulation scheme, when all three filter cells work properly.

6. The method in accordance with claim 1, wherein;
when all of the filter cells work properly, pulse patterns for the main stage and/or for the three filter cells are determined offline in advance and are loaded into one or more look-up tables during the operation of the electrical converter.

7. The method in accordance with claim 1, wherein a switching frequency of the main stage is increased, when the filter cell has failed.

8. The method in accordance with claim 6, wherein an update rate configured to update the look-up tables is reduced when the filter cell has failed.

9. The method in accordance with claim 8, wherein the update rate is reduced to a modulation period of the main stage or to half the modulation period of the main stage.

10. A non-transitory computer-readable storage medium for storing a computer program, wherein the computer program is configured to control an electrical converter, the electrical converter comprising:
a main stage, wherein the main stage is configured to convert a direct current voltage into a three phase intermediate voltage and having three main outputs, one for each phase of the intermediate voltage;
a filter cell stage having three filter cells, wherein:
each filter cell is coupled to a corresponding one of the three main outputs, and
wherein the filter cell stage is configured to modify the corresponding phase of the intermediate voltage; and
three bypass switches configured to bypass the filter cells, wherein each of the three bypass switches is electrically coupled to a corresponding one of the three main outputs and to a cell output of the corresponding filter cell; and
wherein when executed by a processor the computer program comprises instructions that cause the processor to:
determine a main stage pulse pattern for the main stage, wherein the main stage pulse pattern is determined based on a voltage reference signal for the output voltage and wherein the main stage pulse pattern comprises switching instants for the main stage over a next modulation period of the main stage;
determine a cell pulse pattern for the filter cell stage, wherein the cell pulse pattern is determined from a cell output voltage reference signal, which is determined from the voltage reference signal and a main stage voltage signal determined from the main stage pulse pattern, and wherein the cell pulse pattern comprises switching instants for the three filter cells over the next modulation period;
apply at least a next switching instant determined from the main stage pulse pattern and the cell pulse pattern to the electrical converter, when all of the filter cells are working properly; and
apply at least a next switching instant determined from the main stage pulse pattern and a modified cell pulse pattern to the electrical converter, when one of the filter cells fails, wherein:
the failed filter cell is bypassed by activating a corresponding bypass switch of the three bypass switches,
the modified cell pulse pattern is determined based on an the assumption that a cell voltage provided by the failed filter cell is zero, and
the intermediate voltage is modified by the two remaining filter cells based on the modified cell pulse pattern in order to provide the output voltage of the electrical converter.

11. (canceled)

12. A device for controlling an electrical converter, the device comprising:
a processor configured to:
determine a main stage pulse pattern for a main stage of the electrical converter, wherein the main stage pulse pattern is determined based on a voltage reference signal for the output voltage and wherein the main stage pulse pattern comprises switching instants for the main stage over a next modulation period of the main stage;
determine a cell pulse pattern for a filter cell stage of the electrical converter, wherein the cell pulse pattern is determined from a cell output voltage reference signal, which is determined from the voltage reference signal and a main stage voltage signal determined from the main stage pulse pattern, and wherein the cell pulse pattern comprises switching instants for three filter cells of the electrical converter over the next modulation period;
apply at least a next switching instant determined from the main stage pulse pattern and the cell pulse pattern to the electrical converter, when all of the filter cells are working properly; and
apply at least a next switching instant determined from the main stage pulse pattern and a modified cell pulse pattern to the electrical converter, when one of the filter cells fails, wherein:
the failed filter cell is bypassed by activating a corresponding bypass switch of the electrical converter,
the modified cell pulse pattern is determined based on an assumption that a cell voltage provided by the failed filter cell is zero, and
the intermediate voltage is modified by the two remaining filter cells based on the modified cell pulse pattern in order to provide the output voltage of the electrical converter; and
a memory configured to store:
a main stage pulse pattern configured to control a main stage of the electrical converter;
a cell pulse pattern configured to control the filter cell stage, when all of the filter cells are working properly; and
a modified cell pulse pattern configured to control the filter cell stage, when one of the filter cells fails, wherein the memory is communicatively coupled to the processor.

13. The device of claim 12, further comprising:
the main stage, wherein the main stage is configured to convert a direct current (DC) voltage into a three-phase intermediate voltage and having three main outputs, one for each phase of the intermediate voltage;
the filter cell stage comprising the three filter cells, wherein:
each filter cell is coupled to a corresponding one of the three main outputs, and
the filter cell stage is configured to modify the corresponding phase of the intermediate voltage; and
three bypass switches configured to bypass the filter cells, wherein each of the three bypass switches is electrically coupled to a corresponding one of the three main outputs and to a cell output of the corresponding filter cell.

14. The method in accordance with claim 3, wherein the two-dimension auxiliary vector is determined in an αβ-frame.

15. The method in accordance with claim 3, wherein the redistributed reference cell output voltages are determined in form of a two-dimensional redistributed vector and the redistributed vector is provided in the αβ-frame.

16. The method in accordance with claim 1, wherein the main stage and/or the remaining filter cells are operated in accordance with a carrier-based model predictive pulse pattern control (M3PC) modulation scheme, when the filter cell has failed.

17. The method in accordance with claim 1, wherein when the filter cell has failed, the pulse patterns for the main stage and/or for the remaining filter cells are determined online for the next modulation period only and are loaded into the one or more look-up tables during the operation of the electrical converter.

18. The method in accordance with claim 17, wherein an update rate configured to update the look-up tables is reduced when the filter cell has failed.

19. The method in accordance with claim 18, wherein the update rate is reduced to a modulation period of the main stage or to half the modulation period of the main stage.

20. The method in accordance with claim 2, wherein:
the main stage and/or the filter cells are operated in accordance with an optimized pulse patterns (OPP)-based model predictive pulse pattern control (M3PC) modulation scheme, a carrier-based MP3C modulation scheme, or a pulse width modulation (PWM) modulation scheme, when all three filter cells work properly.

21. The method in accordance with claim 2, wherein the main stage and/or the remaining filter cells are operated in accordance with a carrier-based model predictive pulse pattern control (M3PC) modulation scheme, when the filter cell has failed.
